(19) United States
(12) Patent Application Publication
(10) Pub. No.: US 2018/0085761 A1
(43) Pub. Date: Mar. 29, 2018

(54) Using a Cyclone Separator and a Fixed-Bed Gasifier to Generate a Product Gas from Carbon-Containing Input Substances

(71) Applicant: Entrade Energiesysteme AG, Duesseldorf (DE)

(72) Inventors: Horst Dressler, Dietfurt (DE); Michael Hofmeister, Rinchnach (DE)

(21) Appl. No.: 15/809,318

(22) Filed: Nov. 10, 2017

Related U.S. Application Data
(63) Continuation-in-part of application No. PCT/EP2016/060356, filed on May 9, 2016.

(30) Foreign Application Priority Data
May 13, 2015 (DE) 102015208923.1
May 9, 2016 (EP) PCT/EP2016/060356

(51) Int. Cl. B04C 5/04; B04C 5/081; C10B 53/02; C10B 49/02; C10B 27/00; C10J 3/42; C10J 3/20; C10J 3/84

(52) U.S. Cl. CPC B04C 5/04; B04C 5/081; C10B 53/02; C10J 3/84; C10B 27/00; C10J 3/42; C10J 3/20; C10B 49/02

(57) ABSTRACT

A cyclone separator for separating particles from a gas flow includes a gas inlet and a separating element. The separating element includes an upper cylindrical section connected to a gas outlet and a lower conical section connected to a particle outlet. The first end of the gas inlet is on a straight section, and the second end of the gas inlet in on a helical section. The second end is connected to the upper cylindrical section. The cross-sectional area of the gas inlet continually decreases, and the vertical or longitudinal dimension of the gas inlet continually increases from the first end towards the second end. The vertical dimension at the second end equals the diameter of the upper cylindrical section. A guide plate inside the straight section distributes the particles over the increasing vertical dimension of the gas inlet and prevents the particles from concentrating centrally in the gas flow.

### CROSS REFERENCE TO RELATED APPLICATION

This application is filed under 35 U.S.C. § 111(a) and is based on and hereby claims priority under 35 U.S.C. § 120 and § 365(c) from International Application No. PCT/EP2016/060356, filed on May 9, 2016, and published as WO 2016/180791 A1 on Nov. 17, 2016, which in turn claims priority from German Application No. 102015208923.1, filed in Germany on May 13, 2015. This application is a continuation-in-part of International Application No. PCT/EP2016/060356, which is a continuation of German Application No. 102015208923.1. International Application No. PCT/EP2016/060356 is pending as of the filing date of this application, and the United States is an elected state in International Application No. PCT/EP2016/060356. This application claims the benefit under 35 U.S.C. § 119 from German Application No. 102015208923.1. The disclosure of each of the foregoing documents is incorporated herein by reference.

### TECHNICAL FIELD

The invention relates to a cyclone separator and a fixed-bed gasifier for generating a product gas from carbon-containing input substances, such a cyclone separator being downstream of the product gas outlet of the fixed-bed gasifier.

### BACKGROUND

Fixed-bed gasifiers that generate a combustible product gas from biomass pellets, such as wood chips or wood pellets, are characterized by a comparatively simple design. A distinction exists between countercurrent gasifiers and downdraft gasifiers. In a countercurrent gasifier, the combustion air and the product gas flow in a direction opposed to the feed-in direction of the biomass particles. In a downdraft gasifier, however, the feed-in direction of the biomass particles matches the flow direction of combustion air and product gas. Fixed-bed gasifiers have different reaction zones, such as a drying zone, a pyrolysis zone, an oxidation zone and a reduction zone, in which different thermochemical reactions take place.

An overview on the subject of fixed bed gasification of biomass particles was disclosed by Lettner, Haselbacher and Timmerer from the Technical University of Graz, Austria, in the presentation entitled “Festbett-Vergasung-Stand der Technik (Überblick)” (an overview of the state of the art of fixed bed gasification) given on Feb. 27, 2007 at the conference in Leipzig entitled “Thermo-chemische Biomasse-Vergasung für eine effiziente Strom/Kraftstoffbereitstellung-Erkenntnisstand 2007” (thermo-chemical biomass gasification for efficient current/fuel supply—state of the art in 2007). The presentation describes a downdraft shaft gasifier in which the biomass particles are supplied into the gasifier container from above using gravity. In the middle area of the gasifier, combustion air is supplied via nozzles and the product gas is discharged from the lower area of the gasifier container. A drying zone, a pyrolysis zone, an oxidation zone and a reduction zone are arranged from top to bottom in this known fixed-bed gasifier. The oxidation zone is located within the area of the air supply and is to be restricted to that zone. The reduction zone is beneath the oxidation zone and is directly above the grate. The product gas is removed from the area of the gasifier container beneath the grate, through which small particles of ash fall and are collected.

The process of fixed bed gasification causes the product gas to contain solid particles of different sizes. The largest solid particles typically are separated using a downstream cyclone separator. One such cyclone separator is disclosed by German patent DE 4233174 A1. That cyclone separator has a downwardly tapered separating element with a longitudinal axis, a gas outlet reaching into the separating element from above, a particle outlet located on the lower end of the separating element, and a gas inlet leading into the separating element transversely to the longitudinal axis of the separating element. The gas inlet has a first end and a second end; the second end leads into the separating element. The gas inlet widens in an axial direction of the separating element and helically surrounds the separating element. The cross-sectional area of the gas inlet remains substantially constant between the first end and the second end of the gas inlet. A similar cyclone separator is disclosed by German patent DE 825332 B, in which the cross-sectional area between the first and second ends of the gas inlet increases. The particle-separating efficiency of these known cyclone separators is insufficient, particularly when being used for purifying product gas from fixed-bed gasifiers.

It is an object of the present invention to provide a cyclone separator that exhibits separation properties superior to those of the cyclone separators disclosed in DE 4233174 A1 and DE 825332 B. Moreover, it is an object of the invention to provide a fixed-bed gasifier for generating a product gas from carbon-containing input substances using the improved cyclone separator.

### SUMMARY

The invention specifies a cyclone separator with improved separating properties and also a fixed-bed gasifier for generating a product gas from carbon-containing input substances using such a cyclone separator. The gas inlet widens helically in the flow direction. The helical widening of the gas inlet improves the particle-separating efficiency. The widening of the gas inlet assists the forming and maintaining of the vortex flow in the separating element. The reduction in cross-sectional area of the gas inlet increases the flow speed and therefore the efficiency of the particle separation.

The cyclone separator for separating solid particles from a gas flow includes a gas inlet, a separating element, a particle outlet and a gas outlet. In one embodiment, the solid particles are ash produced in a downdraft fixed-bed gasifier during the gasification of biomass particles into wood gas. The separating element includes an upper cylindrical section and a lower conical section. The gas outlet is connected to the upper cylindrical section, and the particle outlet is connected to the lower conical section. The gas inlet has a first end, a second end, a straight section and a helical section. The first end is on the straight section, and the second end is on the helical section. The helical section is connected at the second end to the upper cylindrical section of the separating element. The straight section is oriented perpendicular to the longitudinal axis of the separating element.

The cross-sectional area of the gas inlet continually decreases from the first end towards the second end such that the cross-sectional area at the second end is smaller than the cross-sectional area at the first end. The longitudinal or vertical dimension of the gas inlet is oriented parallel to the longitudinal axis of the separating element. The longitudinal dimension of the gas inlet does not decrease from the first end towards the second end. In one embodiment, the longitudinal dimension of the gas inlet continually increases from the first end towards the second end. The longitudinal dimension of the gas inlet at the second end approximately equals the diameter of the upper cylindrical section. A guide plate is disposed inside the straight section of the gas inlet and runs midway between the upper edge and the lower edge of the straight section. The guide plate distributes the solid particles over the widening longitudinal dimension of the gas inlet and prevents the particles from being concentrated centrally in the gas flow.

In another embodiment, the separating element has a second conical section disposed between the upper cylindrical section and the lower conical section. Adding the second conical section causes the cross-sectional area of the separating element to expand in a jump after first decreasing in a downwardly direction. In yet another embodiment, the cyclone separator has a second separating element. The gas inlet has a second helical section that is connected to the second separating element. The straight section of the gas inlet is connected to both the first helical section and the second helical section.

In yet another embodiment, a fixed-bed gasifier for producing a product gas from biomass particles includes a cyclone separator. The fixed-bed gasifier also includes a gasifier container, a gasifier component, a biomass supply inlet, an air supply inlet, a grate and a product gas vent. The diameter of the gasifier container is larger than the diameter of the gasifier component. The lower open end of the gasifier component extends down into the gasifier container. The supply inlet is adapted to receive the biomass particles into the upper closed end of the gasifier component. Combustion air enters the gasifier component through the air supply inlet near the upper closed end. The grate is adapted to support the biomass particles and is disposed in a lower portion of the gasifier container. The product gas vent leads out of the gasifier container below the grate. The product gas generated from the biomass particles exits the gasifier container through the product gas vent.

The cyclone separator has a separating element and a gas inlet. The gas inlet has a first end, a second end, a straight section and a helical section. The first end is on the straight section, and the second end is on the helical section. The product gas enters the cyclone separator from the product gas vent at the first end of the gas inlet. The helical section is connected at the second end to the separating element. The gas inlet has a cross-sectional area that continually decreases from the first end towards the second end. The gas inlet has a vertical dimension or length that does not decrease from the first end towards the second end. In one embodiment, the vertical dimension of the gas inlet continually increases from the first end towards the second end.

Other embodiments and advantages are described in the detailed description below. This summary does not purport to define the invention. The invention is defined by the claims.

### BRIEF DESCRIPTION OF THE DRAWING

The accompanying drawings, where like numerals indicate like components, illustrate embodiments of the invention.

FIG. 1 is a schematic cross-sectional view of an exemplary embodiment of the cyclone separator of the present invention.

FIG. 2 is a schematic cross-sectional view of the exemplary embodiment of FIG. 1 with the section plane being perpendicular to the section plane of FIG. 1.

FIG. 3 is a schematic perspective view of the embodiment of FIGS. 1 and 2 from the side.

FIG. 4 shows an alternative embodiment of the cyclone separator having two jumps in the cross-sectional area directly before the lock device.

FIG. 5 shows an additional embodiment of the cyclone separator as a double cyclone.

FIG. 6 is a schematic cross-sectional view of an exemplary embodiment of a fixed-bed gasifier that includes a temperature measurement device and a rotary grate.

### DETAILED DESCRIPTION

Reference will now be made in detail to some embodiments of the invention, examples of which are illustrated in the accompanying drawings.

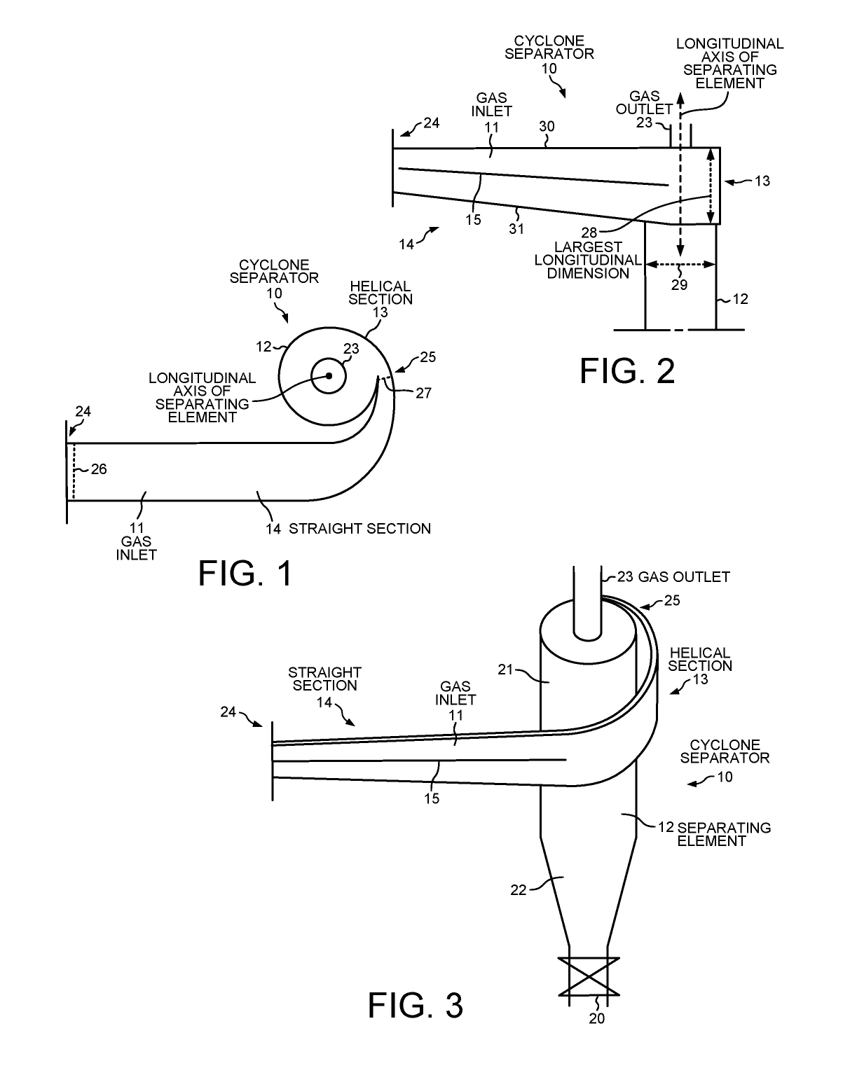

FIG. 1 is a cross-sectional top view of an embodiment of the cyclone separator 10 of the present invention. FIG. 2 is a side view of the cyclone separator 10 of FIG. 1. The particle-separating efficiency of the cyclone separator 10 is improved by the helical widening of the gas inlet 11. The widening of the gas inlet 11 allows the vortex flow in the separating element 12 to be formed and maintained. The reduction in the cross sectional area of the gas inlet 11 increases the flow speed and therefore the efficiency of the particle separation.

Practical experience shows that particle separation is improved by making the minimum cross-sectional area of the helical portion 13 of the cyclone separator 10 between 40% to 60% of the initial cross-sectional area of the inlet to the helical portion. Particle separation is also improved by extending the gas inlet 11 in the axial direction of the separating element 12 by a length corresponding to the largest diameter of the separating element 12. Particle separation is also improved by continuously reducing the cross-sectional area of the gas inlet 11. Homogenous particle distribution is achieved in the straight section 14 of the gas inlet 11. In addition, the straight section 14 also assists with the agglomeration that yields larger particles, which are easier to separate.

Solid particles are distributed over the entire cross-section of the gas inlet 11 by using a guide plate 15 disposed in the expanding cross-section of the gas inlet 11. The cross-sectional expansion of the separating element 12 in jumps results in changes of the speed of the gas flow, which leads to an increased agglomeration of smaller particles into larger particles. This improves the particle separation rate. Improved agglomeration is possible in particular with “sticky” particles, such as coke particles.

An embodiment of the cyclone separator in form of a double cyclone likewise increases the particle separation rate. The particle separation rate decreases in higher gas flows and larger separating elements. The configuration as a double cyclone compensates for the negative effects of higher gas flows and larger separating elements.

An embodiment of a downdraft, fixed-bed gasifier 16 allows for safe and stable process control and provides a continuous flow of product gas with low tar quantities. The product gas is typically wood gas or a gas mixture containing hydrogen gas, carbon monoxide and methane. Air is supplied through a cylindrical gasifier component 17 and into the bed of biomass particles, which results in a uniform distribution of the air. Hardly any temperature differences occur in the oxidation zone 18 of the gasifier container 19 by virtue of the uniform distribution. As a result, even pyrolysis gases generated over the oxidation zone 18 flow through the oxidation zone in a uniform manner. The uniformity of the gas and air flows allows the product gas to be generated with low tar quantities. For additional details on such a configuration of the fixed-bed gasifier 16, see U.S. Patent Application Publication 2017/0275543, which claims priority to German application DE102014225166.4, the subject matter of which is incorporated herein by reference.

FIGS. 1-3 show the exemplary configuration of cyclone separator 10 in accordance with the present invention. Cyclone separator 10 has a downwardly tapered separating element 12 that ends in a particle outlet in the form of a lock device 20 used to remove the separated solid particles. The separating element 12 includes an upper cylindrical section 21 and a lower conical section 22. The cylindrical section 21 has a constant circular cross-section. Beneath the cylindrical section 21 is the conical section 22 that ends with the lock device 20. A tubular gas outlet 23 projects from the cylindrical section 21 on the upper end of the separating element 12. Purified gas with a reduced proportion of solid particles is supplied through the gas outlet 23. The tubular gas outlet 23 extends down into separating element 12 and ends before the conical section 22.

The gas containing solid particles, i.e., the product gas from the fixed-bed gasifier 16, is supplied to separating element 12 through the gas inlet 11 that extends transversely to the longitudinal axis of separating element 12. The gas inlet 11 has a first end 24, a second end 25, the straight section 14 and the helical section 13. The helical section 13 of the gas inlet 11 wraps around a portion of the upper cylindrical section 21 of the separating element 12. The gas containing solid particles enters at the first end 24 of the gas inlet 11 and successively flows through the straight section 14 and then through the helical section 13 and finally enters the cylindrical section 21 of the separating element 12 through the second end 25 of the gas inlet 11. The first end 24 of gas inlet 11 has a rectangular cross-section with a first cross-sectional area 26. The gas inlet 11 widens between the first end 24 and the second end 25 so that the largest longitudinal dimension 28 of gas inlet 11 at the second end 25 approximately corresponds to the diameter 29 of the cylindrical section 21 of separating element 12. The longitudinal dimension of gas inlet 11 is oriented vertically and parallel to the longitudinal axis of separating element 12. While the longitudinal dimension of gas inlet 11 is increasing towards the second end 25, the cross-sectional area of gas inlet 11 is continually decreasing to a minimum cross-sectional area 27 at the second end 25 of gas inlet 11. The ratio of the areas 27 to 26 in the exemplary embodiment is 0.5. The cross-sectional area 26 at the first end 24 should be at least twice a large as the cross-sectional area 27 at the second end 25 of gas inlet 11. By increasing the longitudinal dimension of the gas inlet 11 towards the second end 25, the cross-sectional area 27 is elongated at the second end 25, which leads into the cylindrical section 21 of separating element 12 in an elongated manner and with the smaller cross-sectional area 27. In one embodiment, the longitudinal dimension of the gas inlet 11 continually increases from the first end 24 towards the second end 25. In another embodiment, such as the one depicted in FIG. 2, the longitudinal dimension of the gas inlet 11 does not decrease at any point in the direction from the first end 24 towards the second end 25; there is, however, a portion of the gas inlet 11 over which the longitudinal dimension does not increase.

In the straight section 14 of gas inlet 11, the straight guide plate 15 is oriented in the flow direction, which distributes the solid particles over the widening cross-section of the gas inlet and prevents the particles from being concentrated centrally in the gas flow. The gas inlet 11 has an upper edge 30 and a lower edge 31. The upper edge 30 is perpendicular to the longitudinal axis of the separating element 12. The lower edge 31 forms an obtuse angle with the longitudinal axis and an acute angle with the horizontal axis. The guide plate 15 runs midway between the upper edge 30 and the lower edge 31.

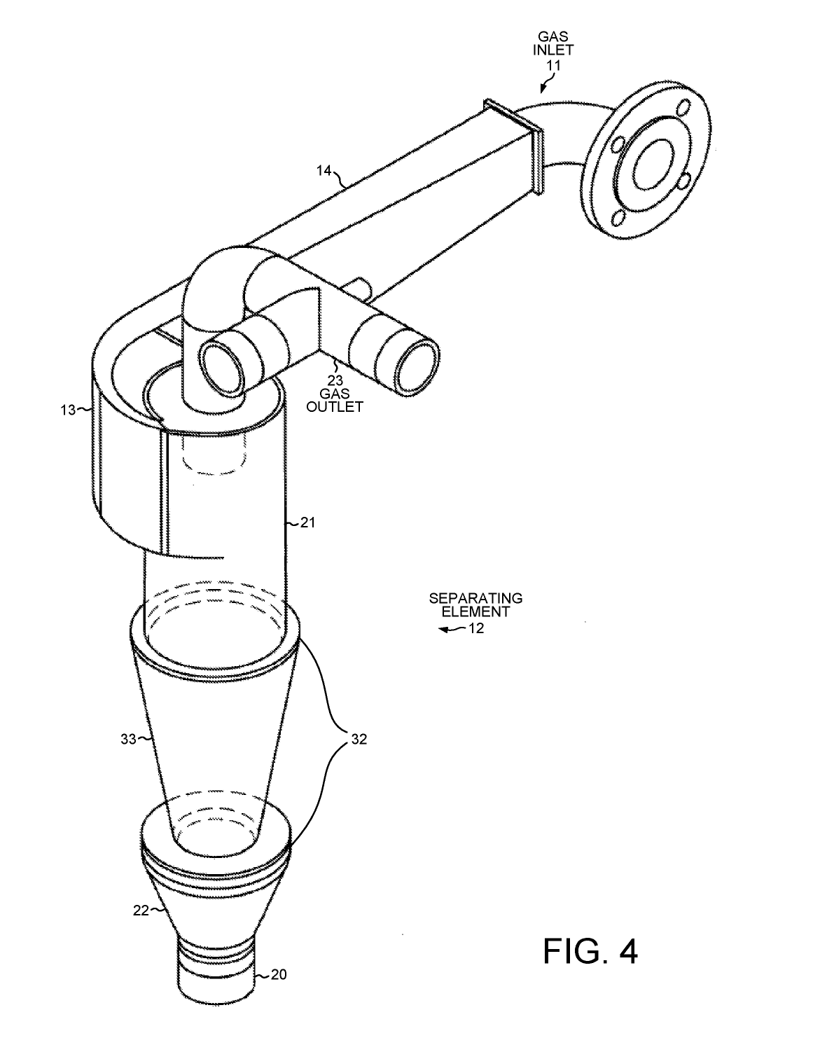

FIG. 4 shows an alternative embodiment of cyclone separator 10 that includes a separating element 12. The cyclone separator has two expansions or jumps 32 in the cross-sectional area of the separating element 12 in the flow direction above the lock device 20. In the embodiment of FIG. 4, the jumps 32 are achieved by adding a second conical section 33 between the upper cylindrical section 21 and the lower conical section 22. The jumps 32 in the cross-sectional area cause a change in the speed of the gas flow and thereby increase the agglomeration of smaller particles into larger ones. As larger particles are easier to separate, the particle separation rate increases.

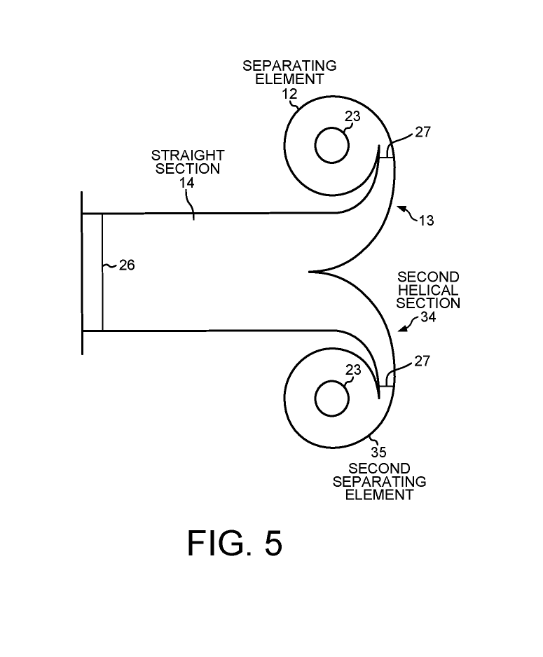

FIG. 5 shows an additional embodiment of cyclone separator 10 in the form of a double cyclone with a common straight section 14 leading into a first helical section 13 and a second helical section 34 rotating in opposite directions. The helical sections 13 and 34 then lead into first and second separating elements 12 and 35.

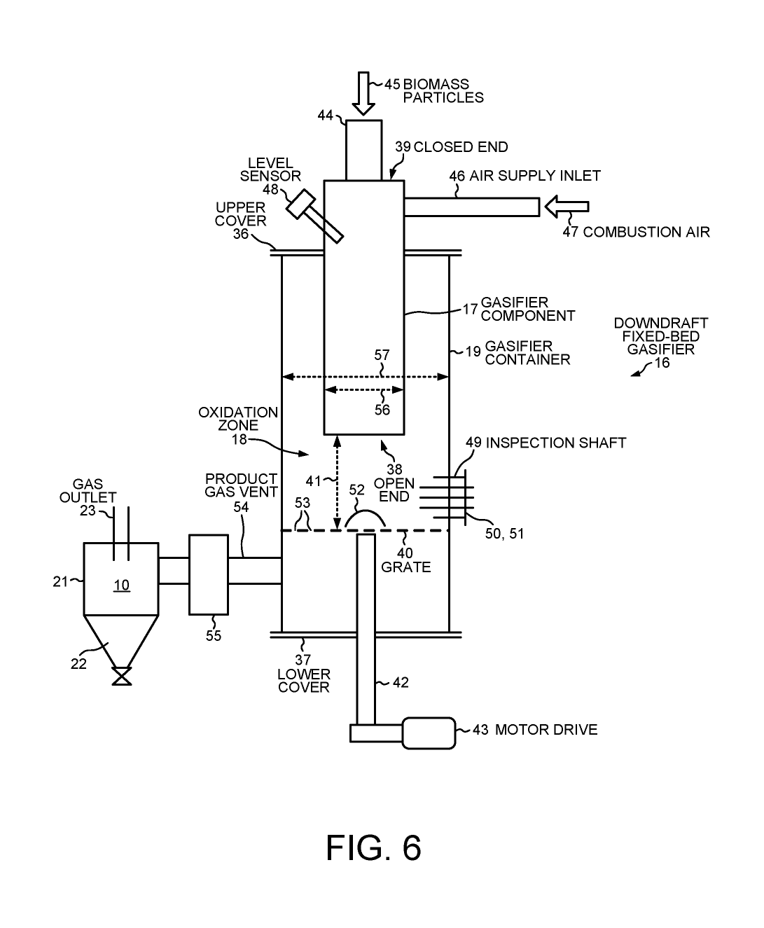

FIG. 6 is a schematic view of an exemplary configuration of a fixed-bed gasifier 16 in accordance with the present invention. The fixed-bed gasifier 16 includes a cylindrical gasifier container 19, the ends of which are closed by an upper cover 36 and a lower cover 37. The cylindrical gasifier component 17 has a lower, open end 38 and an upper, closed end 39. The gasifier component 17 projects down into the gasifier container 19 with the open end 38. The closed end 39 of the gasifier component 17 protrudes out from the gasifier container 19 through the upper cover 36. The lower, open end 38 of gasifier component 17 lies approximately at the middle of gasifier container 19. A rotary grate 40 is disposed at a distance 41 below the open end 38 of the gasifier component 17. The rotary grate 40 can be periodically rotated by the rotational shaft 42 of a motor drive 43 that penetrates up through the lower cover 37. The upper, closed end 39 of gasifier component 17 is penetrated by a supply inlet 44 for carbon-containing input substances such as pourable biomass particles 45, an air supply inlet 46 through which combustion air 47 enters the gasifier container 19, and a level sensor 48 by which the level of biomass particles 45 in the cylindrical gasifier component 17 is determined and monitored. The upper, closed end 39 of gasifier component 17 projects up and out of gasifier container 19. An inspection shaft 49 penetrates the outer wall of gasifier container 19 at the level of the open end 38 of gasifier component 17. The inspection shaft 49 is closed by a covering flange 50 that is part of a temperature measurement device 51. The temperature in the gasifier container 19 is monitored using the temperature measurement device 51. Access into the reactor vessel can be gained through the inspection shaft 49 in order to perform maintenance and cleaning work inside the reactor vessel during the standstill of the reactor.

The rotary grate 40 includes a disk-shaped main part that supports the carbon-containing input substances, such as the biomass particles 45. The main part of the rotary grate 40 is mounted centrally onto the rotational shaft 42 that penetrates the lower cover 37 of gasifier container 19 and is rotated by motor drive 43. A dome-shaped covering 52 is located on the upper side of the rotary grate 40 in the central region above the rotational shaft 42. A plurality of slit-shaped openings 53 are made in concentric circles around the center of the rotary grate 40 and allow ash and product gas to pass through the rotary grate 40.

The product gas is removed from the region of the gasifier container 19 beneath grate 40 through a product gas vent 54. The product gas is then cooled in heat exchanger 55 and purified in a downstream cyclone separator 10. The ashes falling through the grate 40 are also discharged from the fixed-bed gasifier 16 through the product gas flow via the product gas vent 54.

Both the cylindrical gasifier container 19 and the cylindrical gasifier component 17 have a circular cross-section and are arranged concentrically to one another. The cylindrical gasifier component 17 has an inner diameter 56 that is smaller than the inner diameter 57 of the cylindrical gasifier container 19.

### REFERENCE NUMERALS

10 cyclone separator
11 gas inlet of cyclone separator
12 separating element
13 helical section of gas inlet
14 straight section of gas inlet
15 guide plate
16 downdraft, fixed-bed gasifier
17 gasifier component
18 oxidation zone
19 gasifier container
20 lock device of cyclone separator
21 upper cylindrical section
22 lower conical section
23 gas outlet of cyclone separator
24 first end of gas inlet
25 second end of gas inlet
26 cross-sectional area of first end
27 cross-sectional area of second end
28 largest longitudinal dimension of gas inlet
29 diameter of cylindrical section
30 upper edge of straight section of gas inlet
31 lower edge of straight section of gas inlet
32 jumps in area of separating element
33 second conical section of separating element
34 second helical section of gas inlet
35 second separating element
36 upper cover
37 lower cover
38 lower open end of gasifier component
39 upper closed end of gasifier component
40 rotary grate
41 distance from gasifier component to grate
42 rotational shaft of motor drive
43 motor drive
44 supply inlet for carbon substances
45 biomass particles
46 air supply inlet
47 combustion air
48 level sensor
49 inspection shaft
50 covering flange
51 temperature measurement device
52 dome-shaped covering
53 slit-shaped openings in grate
54 product gas vent
55 heat exchanger
56 inner diameter of gasifier component
57 inner diameter of gasifier container

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-13. (canceled)

14. A cyclone separator for separating solid particles from a gas flow, comprising:
a separating element with a longitudinal axis, wherein the separating element includes an upper cylindrical section and a lower conical section;
a gas outlet connected to the upper cylindrical section;
a particle outlet connected to the lower conical section; and
a gas inlet that has a first end, a second end, a straight section and a helical section, wherein the first end is on the straight section and the second end is on the helical section, wherein the helical section is connected at the second end to the upper cylindrical section of the separating element, wherein the straight section is oriented perpendicular to the longitudinal axis of the separating element, wherein the gas inlet has a cross-sectional area at the second end that is smaller than the cross-sectional area at the first end, wherein the cross-sectional area of the gas inlet continually decreases from the first end towards the second end, wherein the gas inlet has a longitudinal dimension oriented parallel to the longitudinal axis of the separating element, and wherein the longitudinal dimension of the gas inlet does not decrease from the first end towards the second end.

15. The cyclone separator of claim 14, wherein the longitudinal dimension of the gas inlet continually increases from the first end towards the second end.

16. The cyclone separator of claim 14, wherein the cross-sectional area at the first end of the gas inlet is at least twice a large as the cross-sectional area at the second end.

17. The cyclone separator of claim 14, wherein the cross-sectional area at the second end of the gas inlet is 60% or smaller than the cross-sectional area at the second end.

18. The cyclone separator of claim 14, wherein the upper cylindrical section of the separating element has a diameter, and wherein the longitudinal dimension of the gas inlet at the second end approximately equals the diameter of the upper cylindrical section.

19. The cyclone separator of claim 14, wherein the gas outlet is tubular and protrudes down into the upper cylindrical section from above.

20. The cyclone separator of claim 14, wherein the helical section of the gas inlet wraps around a portion of the upper cylindrical section of the separating element.

21. The cyclone separator of claim 14, wherein the solid particles are ash produced by the gasification of biomass particles into wood gas.

22. The cyclone separator of claim 14, wherein the straight section of the gas inlet has an upper edge and a lower edge, and wherein the upper edge is oriented perpendicular to the longitudinal axis of the separating element.

23. The cyclone separator of claim 22, wherein a guide plate is disposed inside the straight section of the gas inlet, and wherein the guide plate runs midway between the upper edge and the lower edge.

24. The cyclone separator of claim 14, wherein the separating element has a second conical section disposed between the upper cylindrical section and the lower conical section.

25. The cyclone separator of claim 14, wherein the cross-sectional area of the separating element expands in a jump after decreasing in a downwardly direction.

26. The cyclone separator of claim 14, further comprising:
a second separating element, wherein the gas inlet has a second helical section that is connected to the second separating element, and wherein the straight section of the gas inlet is connected to both the helical section and the second helical section.

27. A fixed-bed gasifier for producing a product gas from biomass particles, comprising:
a gasifier container with a first diameter;
a gasifier component with a second diameter, an upper closed end and a lower open end, wherein the lower open end of the gasifier component extends down into the gasifier container, and wherein the first diameter is larger than the second diameter;
a supply inlet adapted to receive the biomass particles into the upper closed end of the gasifier component;
an air supply inlet that enters the gasifier component near the upper closed end and through which combustion air enters the gasifier component;
a grate adapted to support the biomass particles that is disposed in a lower portion of the gasifier container;
a product gas vent leading out of the gasifier container below the grate and through which the product gas generated from the biomass particles exits the gasifier container; and
a cyclone separator having a separating element and a gas inlet, wherein the gas inlet that has a first end, a second end, a straight section and a helical section, wherein the first end is on the straight section and the second end is on the helical section, wherein the product gas enters the cyclone separator from the product gas vent at the first end of the gas inlet, wherein the helical section is connected at the second end to the separating element, and wherein the gas inlet has a cross-sectional area that continually decreases from the first end towards the second end.

28. The fixed-bed gasifier of claim 27, wherein the gas inlet has a vertical dimension that does not decrease from the first end towards the second end.

29. The fixed-bed gasifier of claim 27, wherein the gasifier component is arranged coaxially with respect to the gasifier container.

30. The fixed-bed gasifier of claim 27, wherein the grate is rotatable.

31. The fixed-bed gasifier of claim 27, wherein the cyclone separator is adapted to separate ash from the product gas which are produced by the gasification of the biomass particles.

32. The fixed-bed gasifier of claim 27, wherein a heat exchanger is disposed between the product gas vent and the gas inlet of the cyclone separator.
